(19) United States
(12) Patent Application Publication
(10) Pub. No.: US 2003/0052474 A1
(43) Pub. Date: Mar. 20, 2003

(54) Stroller seat back leaning angle adjusting device

(76) Inventors: Cheng-Fan Yang, Tainan Hsien (TW); Chuan-Ming Yeh, Chia-I Hsien (TW)

Correspondence Address: BIRCH STEWART KOLASCH & BIRCH, PO BOX 747, FALLS CHURCH, VA, 22040-0747, US

(21) Appl. No.: 10/241,529

(22) Filed: Sep. 12, 2002

(30) Foreign Application Priority Data
Sep. 14, 2001 (TW) 90215855

(51) Int. Cl. B62B 7/06

(52) U.S. Cl. 280/642; 280/47.4

(57) ABSTRACT

A leaning angle adjusting device is disclosed to adjust the leaning angle of the seat back on a stroller. The invention includes a flexible strap on the back of the seat back for providing support and a constraining element on the strap. The constraining element can arbitrarily adjust the support length of the strap so that the leaning angle of the seat back can vary within a desired range. The disclosed adjusting device is not only simple in operation but also provides a good positioning effect. The seat back is thus stably maintained at the leaning angle.

### BACKGROUND OF THE INVENTION

1. Field of Invention

The invention relates to a stroller seat back angle adjusting device and, in particular, to an angle adjusting device combined to a seat back for fixing it to a desired position.

2. Related Art

Most of current baby strollers have a collapsible structure so that they can be easily stored, moved, or carried at its minimal volume. The seat back of the stroller can be fixed or adjustable. The leaning angle of the fixed seat back cannot be adjusted, while the adjustable seat back is slidably mounted on the stroller so that its leaning angle can be changed. In the U.S. Pat. Nos. 5,457,323 and 5,482,311, designs of strollers with the function of adjusting the leaning angle of the seat back are disclosed. The seat back is supported on a backrest frame that can be rotationally positioned and changes its leaning angle with the backrest frame. In practice, the backrest frame is adjusted and positioned by a positioning device. The backrest frame can be moved to a desired leaning angle at the user's will.

It is thus seen that both of the above-mentioned patents have already disclosed the design of an adjustable seat back that is supported by a backrest frame with a variable leaning angle. However, it is also seen that the disclosed embodiments utilize a hook means to achieve the goal of positioning. Using this method, the backrest frame can be fixed at each prepared hook position. Even though this kind of designs provides many positioning angles so that the seat back can be adjusted to a comfortable position, in many cases, however, there are still certain situations where the provided leaning angles are not completely satisfactory.

To treat this problem, the U.S. Pat. No. 5,738,410 proposed a seat back positioning structure that changes the leaning angle continuously. The seat back can move and get positioned at any angle within a range without any limitation. In this case, the stroller is provided with an adjustable strap on the back of the seat back. It is comprised of two side straps, fastened on both sides of the stroller frame, and a central strap, whose both ends are connected with buckles so that the free ends of the two side straps can go through the buckle holes, forming an adjustable strap. The seat back with this structure is allowed to adjust the length of the adjustable strap for the seat back to change its leaning angle. Within the adjustable range, there is no limitation at all.

It is seen from the above-mentioned patent that pulling the two side straps to the sides shortens the length of the adjustable strap, providing the seat back a smaller leaning angle. On the other hand, adjusting the side straps in the opposite way elongates the length from the buckles to the fixed ends, giving the seat back a larger leaning angle. Nevertheless, extending the length of the two side straps to obtain a larger leaning angle requires the release of the two side straps, which is not as easy as shortening the side straps. Moreover, the buckles and the side straps are coupled and fixed through the friction in between. It is still possible for slide to occur between the side straps and the buckles, especially when an external force, such as the weight of the baby sitting in there, is imposed thereon. As a consequence, the seat back often cannot be fixed at the desired leaning angle.

### SUMMARY OF THE INVENTION

In view of the foregoing, an objective of the invention is to provide a device for adjusting the leaning angle of the seat back of a stroller. In particular, the user can quickly and conveniently complete the adjustment. In addition, the seat back can be ensured with a good positioning effect.

To achieve the above objective, the disclosed leaning angle adjusting device includes a supportive flexible strap on the back of the seat back and a constraining element mounted on the strap. The constraining element can arbitrarily adjust the supportive length of the strap on the seat back so that the seat back can make arbitrary leaning angle adjustment within an allowed range. Such an adjusting device is not only simple in its operation, but further provides an ideal positioning effect. Therefore, the seat back can be stably maintained at a fixed leaning angle.

### BRIEF DESCRIPTION OF THE DRAWINGS

The invention will become more fully understood from the detailed description given hereinbelow illustration only, and thus are not limitative of the present invention, and wherein:

FIG. 1 is a three-dimensional view of a preferred embodiment of the invention;

FIG. 2 is a three-dimensional exploded view of the invention;

FIG. 3 is a cross-sectional view of the invention;

FIGS. 4 and 5 schematically show how the invention is used; and

FIG. 6 is a schematic view of adjusting the leaning angle of the seat back on a baby stroller.

### DETAILED DESCRIPTION OF THE INVENTION

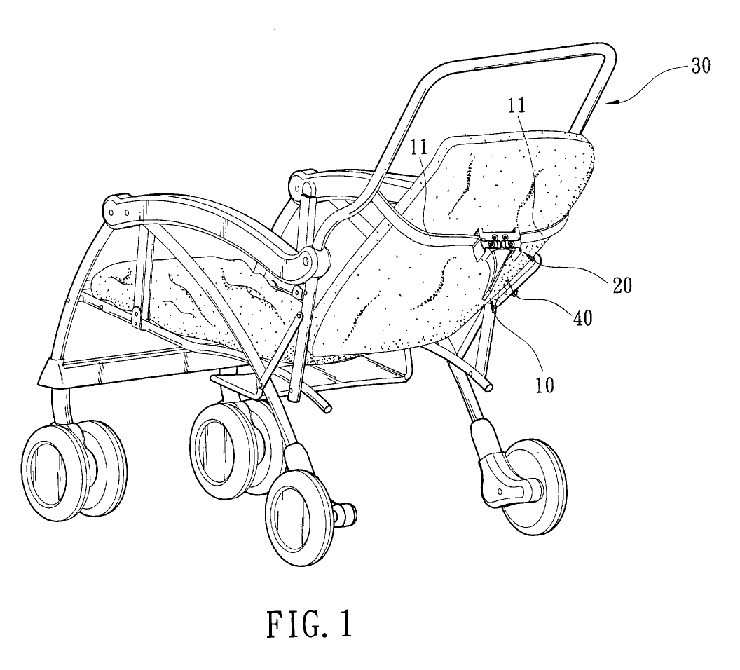

The invention is an adjusting device applied to strollers to help adjusting the supportive leaning angle of the seat back. With reference to FIG. 1, a preferred embodiment of the invention contains: at least one flexible strap 10 and a constraining element 20. The flexible strap 10 may be a long strap made of natural or synthetic leather, metal, cotton, and plastics. The strap 10 is fastened or seamed onto the stroller frame 30 in such a way that the strap 10 has a section in an effective area on the back of the seat back 40. This section provides support for the seat back 40 and keeps it at a desired position.

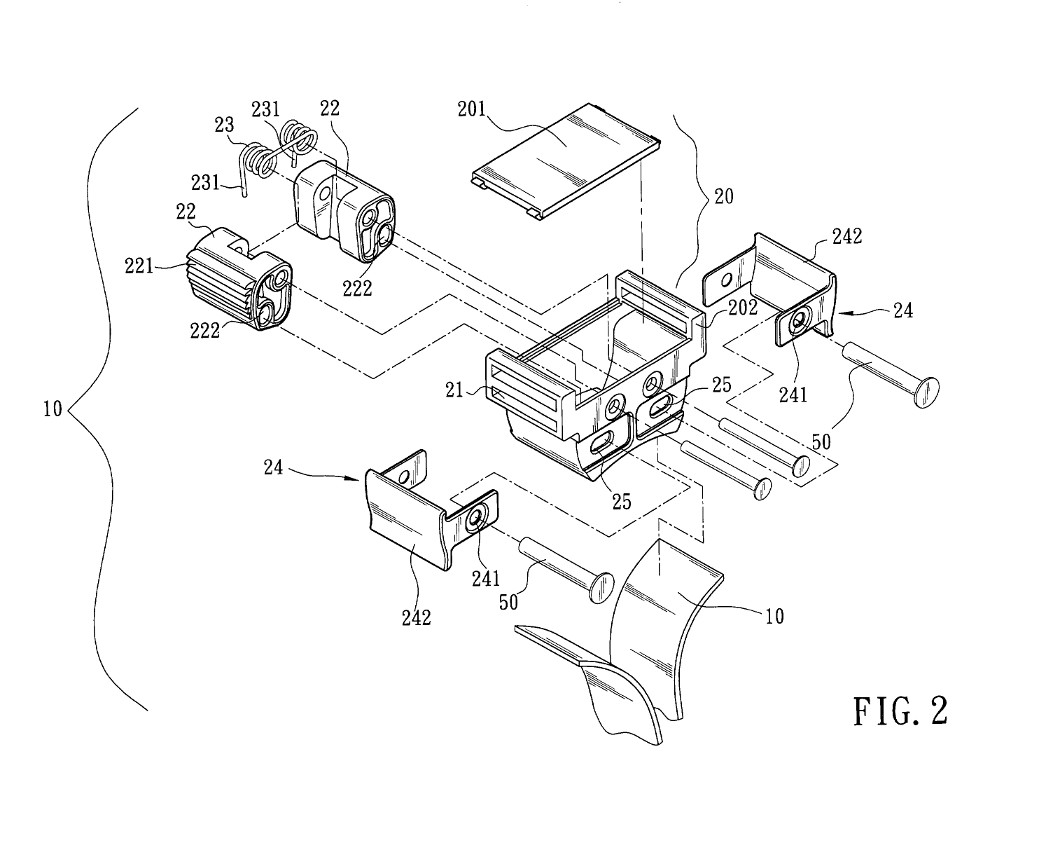

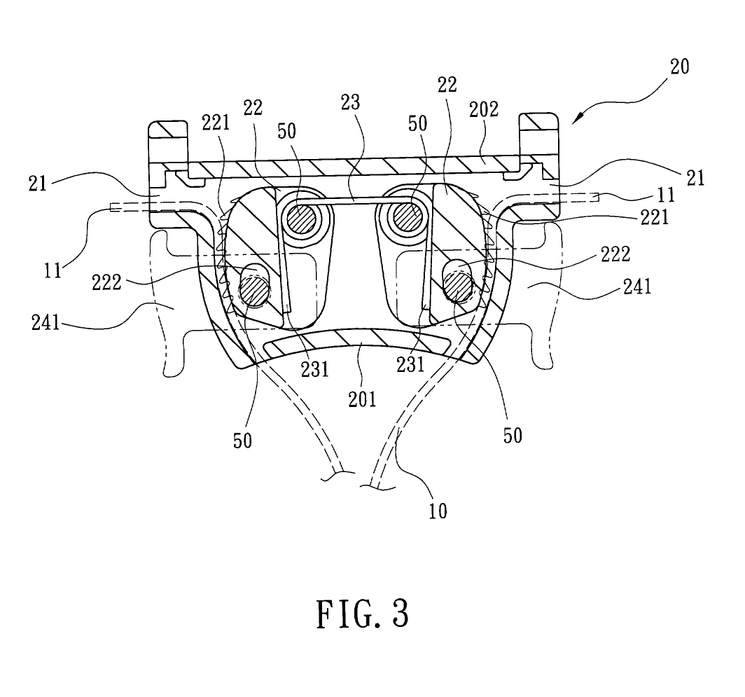

With simultaneous reference to FIGS. 2 and 3, the constraining element 20 is slidably mounted on the strap 10 that changes the supportive length for the seat back 40 in the effective area 11. As shown in the drawings, the constraining element 20 is a hollow structure. In practice, it may be composed of a hollow body 201 and a cover 202. Both sides of the hollow structure are formed with through holes 21 for the strap 10 to go through. The constraining element 20 can slide relative to the strap. The constraining element 20 is combined with a detent element 22, an elastic element 23, and a release element 24. The detent element 22 is pivotally installed on the constraining element 20 through a pin 50. The detent element 22 can rotate between a move position where the strap 10 can move relative to the constraining element 20 and a stop position where the strap 10 is constrained and not allowed to slide. In practice, the detent element 22 is formed with a tooth part 221 or other mechanism with large friction (such as a rough surface) so that there is a larger friction between the detent element 22 and the strap 10 at its stop position.

The elastic element 23 is another component provided inside the constraining element. It can be a spring or other elastic substance. As disclosed herein, the elastic element 23 is a torsion spring. The elastic element 23 has a push top 231 for pushing the detent element 22. The detent element 22 is thus normally maintained at its stop position, keeping the constraining element 20 and the strap 10 fixed.

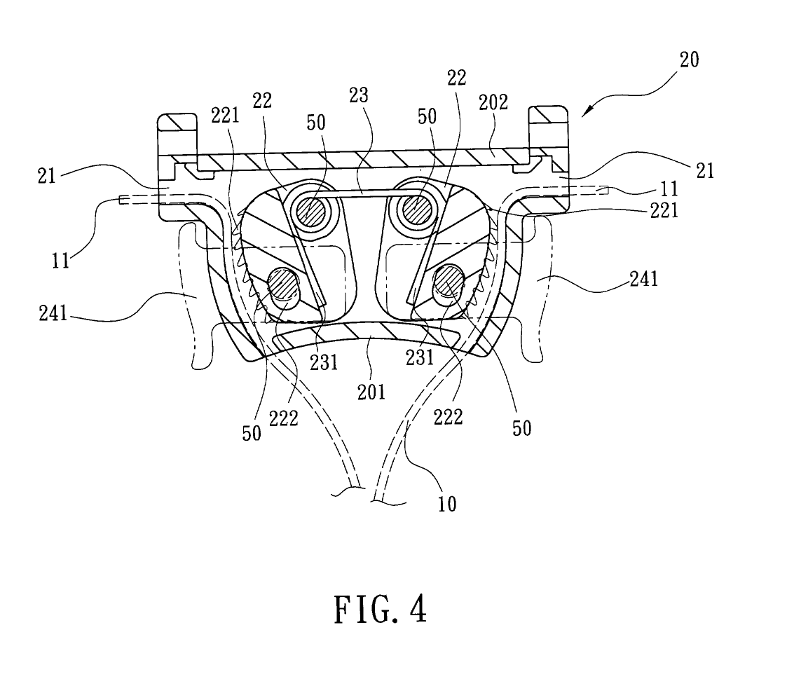

The release element 24 is combined onto the constraining element 20. An axial hole 241 is formed on the release element 24. A pin 50 then goes through the axial hole 241, a corresponding connection hole 222 on the detent element 22, and a long hole 25 on the constraining element 20. The release element 24 uses the motion of the pin 50 inside the long hole 25 to control the detent element 22. The release element 24 has a pressure-bearing part 242 for receiving an external force. The pressure-bearing part 242 drives the detent element 22 into motion in response to the external force, making the detent element 22 move from the stop position (FIG. 3) to its move position (FIG. 4).

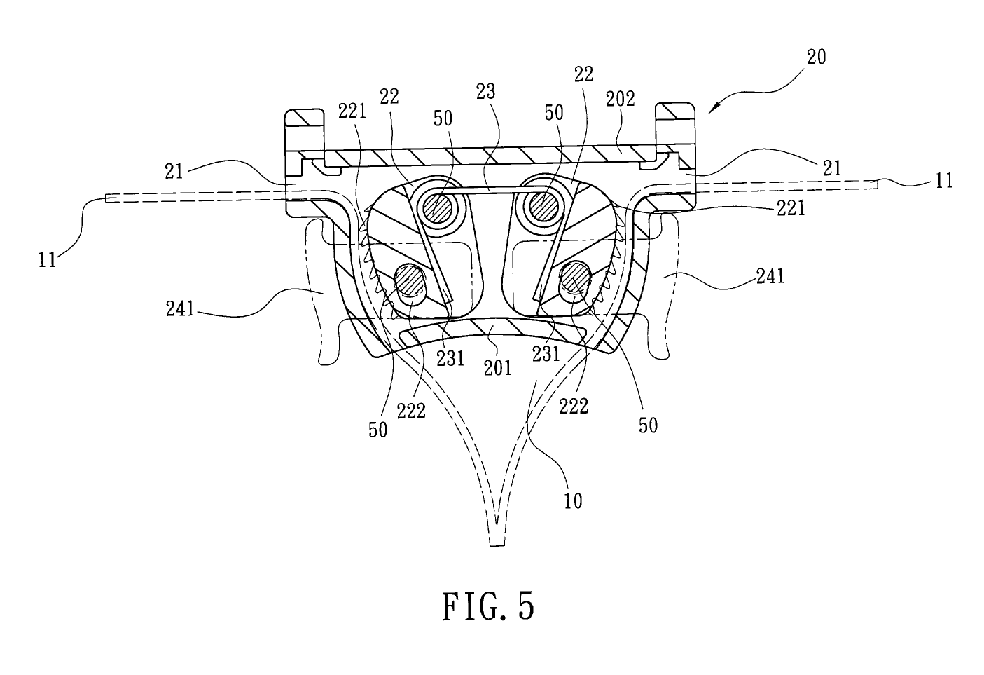

Once the release element 24 is pulled by a force and thus moves the detent element 22 to its move position, the friction between the detent element 22 and the strap 10 disappears, allowing the constraining element 20 to move freely relative to the strap 10 to another position (FIG. 5). When the external force imposed on the release element 24 is removed, the constraining element 20 stops moving again due to the contact friction between the detent element 22 and the strap 10.

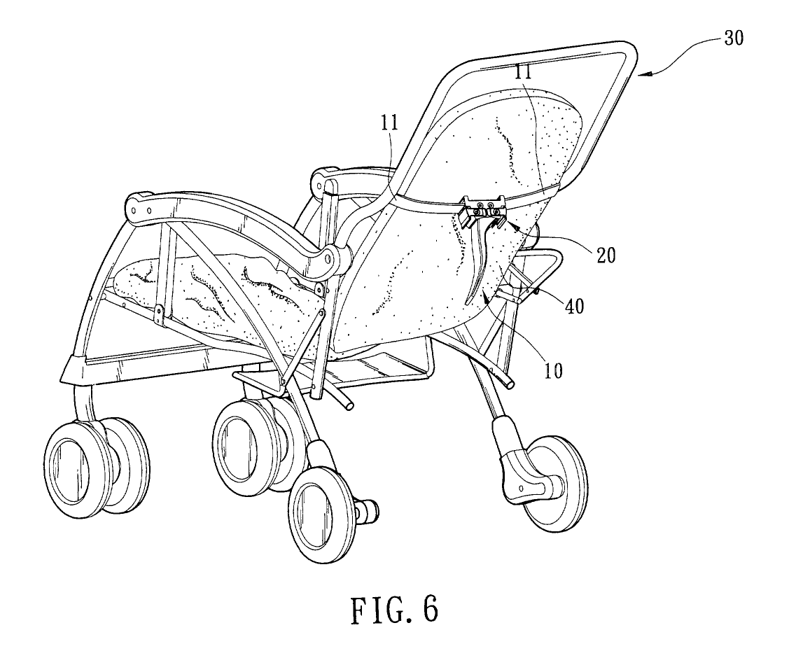

In summary, the different positions of the constraining element 20 along the strap 10 defines the length of the strap 10 in the effective area 11 on the back of the seat back 40, positioning the seat back 40 at different leaning angles (FIGS. 1 and 6).

Effects of the Invention

From the above description, it is seen that the device for adjusting the leaning angle of the seat back of the stroller achieves the following effects:

(1) Simple operation. The strap supports the seat back in the effective area behind it. If the user wants to extend the length (the seat back lying down further at a larger leaning angle), he/she only needs to pull the release element using one hand, separating the detent element and the strap. The constraining element can then be pulled using the other hand or be moved with the weight of the seat back. On the other hand, if one wants to shorten the length in the effective area (the seat back going up at a smaller leaning angle), he/she only needs to hold the strap using one hand while pulling the constraining element using the other.

(2) Good positioning. The constraining element achieves the constraining effect using the friction between the detent element and the strap. As the detent element has a tooth part, it provides a larger resistance than a smooth contact surface, thereby providing better grasping effects. The seat back is then stably maintained at the desired leaning angle.

What is claimed is:

1. A device for adjusting the leaning angle of a stroller seat back, which comprises:
a flexible strap, which connects to the stroller and supports the seat back in an effective area behind it; and
a constraining element, which is slidably mounted on the strap and has at least one detent element with a tooth part;
wherein the constraining element is pushed by an elastic element in its normal state so that the tooth part is engaged at a stop position of the strap, fixing the constraining element on the strap; and the constraining element moves the tooth part away from the strap to a move position when an external force is imposed, making the constraining element move freely relative to the strap, thereby adjusting the length of the strap in the effective area.

2. The device of claim 1, wherein the strap is a woven strap.

3. The device of claim 1, wherein the constraining element is formed with through holes for the strap to go through, thereby mounting the constraining element on the strap.

4. The device of claim 1, wherein the constraining element is a hollow object to accommodate the detent element, the elastic element, and the release element.

5. The device of claim 1, wherein the detent element is pivotally installed on the constraining element.

6. The device of claim 1, wherein the elastic element is a torsion spring mounted in the constraining element.

7. The device of claim 1, wherein the constraining element is further installed with at least one release element, which is pulled by an external force to move the detent element to its move position.
